(19) United States
(12) Patent Application Publication
(10) Pub. No.: US 2021/0387460 A1
(43) Pub. Date: Dec. 16, 2021

(54) CURL COMPENSATION THROUGH SELECTIVE INK DEPLETION

(71) Applicant: Hewlett-Packard Development Company, L.P., Spring, TX (US)

(72) Inventors: Loreal E. Camp, Vancouver, WA (US); James M. Brenner, Vancouver, WA (US); Morgan T. Schramm, Vancouver, WA (US)

(73) Assignee: Hewlett-Packard Development Company, L.P., Spring, TX (US)

(21) Appl. No.: 17/288,523

(22) PCT Filed: Mar. 1, 2019
(86) PCT No.: PCT/US2019/020417

§ 371 Date: Apr. 24, 2021

(51) Int. Cl. B41J 2/205; B41J 2/045; B41J 11/00

(52) U.S. Cl. CPC B41J 2/2054; B41J 2203/011; B41J 11/0005; B41J 2/04508

(57) ABSTRACT

Examples of curl compensation through selective ink depletion are described. In an example, whether printing in a region of a page is likely to produce curling of the page may be determined based on a page location and a print density of the region. The region of the page may be printed with a depleted amount of an ink in response to determining that printing the region at the page location with the print density is likely to produce curling of the page.

### BACKGROUND

Printing devices may apply a print substance, which can include printing agents or colorants, to a printed media sheet such as paper. A printing device may include a black print substance and/or color print substances. In some examples, some inks used by a printing device may lack anti-curl properties.

### BRIEF DESCRIPTION OF THE DRAWINGS

FIG. 1 is a block diagram of an example of a printing device that may be used for curl compensation through selective ink depletion;

FIG. 2 is a block diagram of an example of an apparatus that may be used in an example of a method for curl compensation through selective ink depletion;

FIG. 3 is a flow diagram illustrating an example of a method for curl compensation through selective ink depletion;

FIG. 4 is a flow diagram illustrating another example of a method for curl compensation through selective ink depletion; and

FIG. 5 is a flow diagram illustrating yet another example of a method for curl compensation through selective ink depletion.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Printing devices—including printers, copiers, fax machines, multifunction devices including additional scanning, copying, and finishing functions, all-in-one devices, and pad printers to print images on three dimensional objects—apply a print substance, which can include printing agents or colorants, to a substrate. A substrate is a superset of print media, such as plain paper, and can include any suitable object or materials to which a print substance from a printing device is applied. For ease of explanation, a substrate is referred to herein as a “page.” Print substances, including printing agents and colorants, are a superset of inks and can include liquid inks, or other suitable marking material that may or may not be mixed with fusing agents, detailing agents, or other materials and can be applied to the substrate. For ease of explanation, a print substance is referred to herein as “ink.”

This disclosure relates to methods for mitigating curling of a page by selective ink depletion. In some cases, applying ink on a page may result in curling. Some inks used by a printing device may lack anti-curl properties. To minimize curling, the amount of ink used to print certain regions of a page may be depleted. As used herein, the terms “depletion” and “depleted” refer to an amount that a print substance (e.g., ink) is reduced from a full-color version. For example, a region may be identified in which curling is likely to occur. Then, the region may be printed with a depleted amount of ink to minimize curl.

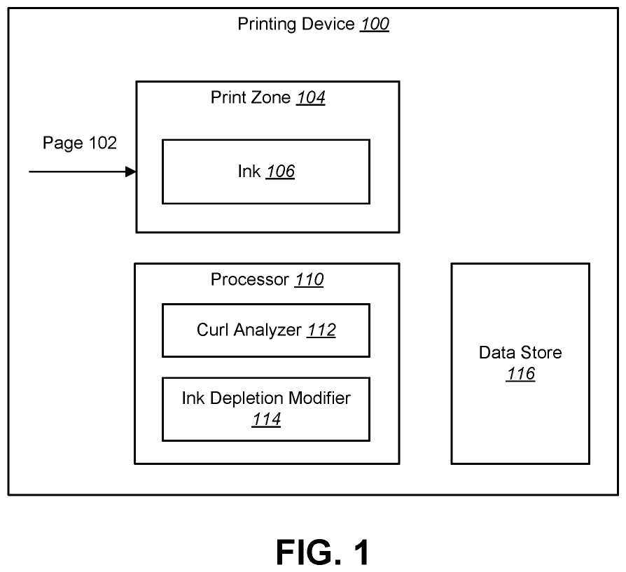

FIG. 1 is a block diagram of an example of a printing device 100 that may be used for curl compensation through selective ink depletion. The printing device 100 (e.g., a page-wide inkjet printer) may modify how it prints a page 102 based on the likelihood that curl will occur.

The printing device 100 may include a processor 110. In some examples, the processor 110 may be a computing device, a semiconductor-based microprocessor, a central processing unit (CPU), a graphics processing unit (GPU), field-programmable gate array (FPGA), an application-specific integrated circuit (ASIC), and/or other hardware device. The processor 110 may be connected to other components of the printing device 100 via communication lines (not shown).

The processor 110 may control motors and/or actuators (not shown) to control operations of the components of the printing device 100. For example, the processor 110 may control a motor (not shown) that determines the speed of printing in a print zone 104. The processor 110 may also control actuators that control the deposition of ink 106 on the page 102. The processor 110 may also control actuators that control the feeding of ink 106 into the printhead(s) (not shown). The processor 110 may further control conditioning processes in a conditioner and/or finishing operations in a finisher.

As used herein, the print zone 104 is a region of the printing device 100 that includes components to deposit ink 106 onto the page 102. The print zone 104 may include a number of printheads having nozzles to eject ink 106 onto the page 102.

The processor 110 may communicate with a data store 116. The data store 116 may be a machine-readable storage medium. Machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like. The data store 116 may be referred to as memory.

The data store 116 may include data pertaining to the page 102. For example, the data store 116 may store data pertaining to images to be printed on a printed side of the page 102. In an example of a duplex page 102, the data store 116 may store data pertaining to images to be printed on a first side and a second side of the page 102.

As described below, a machine-readable storage medium may also be encoded with executable instructions for curl compensation through selective ink depletion. For example, the data store 116 may include machine-readable instructions that cause the processor 110 to determine that printing in a region of a page 102 is likely to produce curling of the page 102 based on a page location and a print density of the region. The data store 116 may also include machine-readable instructions that cause the printing device 100 to print the region of the page 102 with a depleted amount of ink 106 in response to determining that printing in printing the region at the page location with the print density is likely to produce curling of the page 102.

In some cases, moisture from the ink 106 may interact with the media substrate to negatively impact the quality of the media substrate. For example, ink moisture may produce a curled media in addition to creating a soft, soggy feel to the page 102. The curling caused by ink moisture may also result in difficulties when a page 102 is compiled in a finisher (not shown). As used herein, “compile” refers to organizing or grouping a number of printed pages. Finishing operations may also include stacking and/or stapling pages.

Curl is a property of paper that relates to its flatness. When laying a sheet, or stack of sheets, on a flat surface such as a desktop, the sheets should lay flat on the surface. Curl is the measurement of a lack of flatness where some portion of the page 102 curves away from the flat surface. In extreme curl, the page 102 may even wrap on itself forming a roll. Curl is undesirable in finished output. Curl is difficult to handle in a mechanism (e.g., printing device 100) designed to handle a flat page 102.

When paper is manufactured, there is tension between the fibers of the paper. When the paper dries, the fibers lock together. This puts the paper under tension. When an ink 106 wets the page 102 during printing, the tension in the paper fibers is released. When this occurs, the page 102 may curl. Usually the page 102 curls away from the ink side and to the dry side. The curl may be especially severe when the ink 106 wets the page 102 unevenly (e.g., one side of the page 102 is wet while the other side is not wet).

When printing on paper, the action of adding ink 106 can cause the paper to curl. Adding ink 106 uniformly across a page 102 may result in a soft, soggy page, but a page 102 that does not curl significantly. However, adding ink 106 to select locations on a page 102 (referred to herein as regions) will create a non-uniform stress load across the fiber web within the paper. This non-uniform stress may result in a curl. For example, curl may occur when ink 106 is deposited along one side of a page 102, but not the other side of the page 102.

The resulting curl may present challenges for both the mechanism (e.g., printing device 100) and the end user. Curled pages 102 are more difficult for the mechanism to successfully process without causing a jam or user intervention. Even if curled pages 102 are outputted successfully, they may be less desirable for the end user as the curled pages 102 have worse handle-ability, stack-ability and/or visual appearance as compared to flat pages 102.

In some approaches, inks may have anti-curl properties to inhibit curl. For example, for inks with anti-curl properties, materials or chemicals may be added to the inks that help to prevent curl. For example, these anti-curl agents may help to prevent the formation of stresses, or to evenly distribute the stresses caused by printing and thus reduce curl. In some approaches, anti-curl agents are used in all of the ink that is used in by the printing device 100.

Not all inks have anti-curl agents, nor are all inks chemically or visually compatible with the various anti-curl agents. Furthermore, in some cases the anti-curl agents are incompatible with other aspects of the ink. For example, issues with shelf life, material compatibility, or visual attributes such as optical density may be adversely affected by the addition of these anti-curl agents. In some examples, the ink 106 described herein may lack anti-curl agents.

In some approaches, when anti-curl agents are incompatible with an ink, mechanical additions to the printing device 100 are made to compensate for curling pages. These mechanical additions may include extra rollers, surfaces, dryers, fusers, and hold-downs. These mechanical additions result in additional cost, complexity, and/or reduced performance of the printing device 100. The methods described herein overcome these deficiencies by selectively depleting the amount of ink 106 that is used in certain regions of the page 102 to minimize the formation of curl.

With the methods described herein, the amount of ink 106 deposited on the page 102 may be locally depleted to reduce curl in the output. These changes to the ink 106 may include reducing the amount of ink 106 that is applied to the page 102.

In some examples, the print zone 104 of the printing device 100 may use an ink 106 ink lacking anti-curl properties. For example, the ink 106 may be a black ink lacking an anti-curl agent. In some examples, the ink 106 may be used for monochrome printing. In some other examples, the ink 106 may be used for color printing.

The processor 110 may include a curl analyzer 112. The curl analyzer 112 may determine that printing in a region of a page 102 is likely to produce curling of the page 102 based on a page location and a print density of the region. In some examples, determining whether curling is likely to occur may be based on determining that the page location of the region is associated with page curl. In other words, the curl analyzer 112 may determine whether the page 102 is likely to curl based on the location on the page 102 where the ink 106 is to be applied. It should be noted that in some examples, the curl analyzer 112 may be a representation of instructions executed by the processor 110.

In this approach, the curl analyzer 112 may determine whether the ink 106 will be printed in a region of the page 102 that is likely to curl. Certain regions of the page 102 may be identified as likely to produce curl when printed. For example, ink on the bottom edge and/or top edge of the page 102 may produce curl of the page 102. Printing in a bottom region or top region may be troublesome for a finishing operation (e.g., stapler and/or stacker), which leads to an increased frequency of jams. For example, dense areas of the ink 106 (e.g., black ink) in the bottom region or top region of the page 102 are likely to result in curling, which may negatively impact the performance of the finishing operation. Therefore, the curl analyzer 112 may determine that the region is located at a top or bottom edge of the page 102.

Other regions of the page 102 may also be known to cause curling. For example, a high concentration of the ink 106 on the edges of the page 102 may be likely to cause curling. The curl analyzer 112 may determine whether or not the ink 106 is to be applied in a region of the page 102 that is likely to cause curling.

When determining whether printing in a region of the page 102 is likely to cause curling, various parameters may be considered. For example, the page 102 may be subdivided into multiple regions. The regions may be defined by a length, width and/or location on the page. In an example, a top region may be located at the top of the page 102. The top region may be defined as a rectangular block that spans the width of the page 102 and has a length of two inches. It should be noted that this is one example of how a region may be defined. This top region may be defined with other dimensions. Furthermore, other regions may also be defined on the page 102.

Certain patterns of the ink 106 may be likely to cause curling of the page 102. As used herein, a “pattern” refers to a variation in the amount of ink 106 deposited in one region of the page 102 as compared to another region of the page 102. In some examples, the curl analyzer 112 may determine whether the ink 106 is to be deposited on the page 102 with a certain pattern that is likely to cause curling. For example, if a certain region of the page is to have a large concentration of the ink 106 and this region borders (e.g., is located next to) another region that does not include the ink 106, then the curl analyzer 112 may identify this case as likely to cause curling. Therefore, determining that printing in a region of the page 102 is likely to produce curling on the printed page 102 may include determining that the region is located next to an unprinted region of the page 102. As used herein, an “unprinted region” is a region in which no (or minimal) ink 106 is to be deposited on the page 102.

In an example, a pattern that is likely to cause curl may include a two-inch block of black ink 106 that borders a region of white where no (or minimal) ink 106 is deposited on the page 102. It should be noted that the dimensions in this example are provided for illustrative purposes and may vary based on ink formulation, media properties, print speed and other print properties.

In some examples, determining that printing in a region of the page 102 is likely to produce curling of the page 102 may include determining that the print density in the region exceeds a print density threshold for the page location of the region. As used herein, the print density is an amount of ink 106 deposited within a region of the page 102. For example, using the ink 106 to produce text may not be likely to cause curling because the print density is less than a print density threshold. However, a certain amount of the ink 106 may be likely to cause curling of the page 102. The curl analyzer 112 may determine if the print density of the ink 106 would exceed a print density threshold indicating that curling is likely. It should be noted that the print density threshold may be dependent on the particular formulation of the agents, colorants, and/or ink 106 used.

In some examples, the print density threshold may be based on the page location of the region. Because print densities for the ink 106 may affect curl differently in different regions, the print density thresholds may vary for the different regions. For example, a region located at the top or bottom of the page 102 may be more susceptible to curling. Therefore, the top region and bottom region may have a lower print density threshold than other regions of the page 102.

Using ink-based printing as an illustrative example, in some implementations, the print density may be measured as the predicted number of ink droplets to be deposited within a region of the page 102. In an implementation, the print density may be expressed as a number of ink droplets per unit area (e.g., mm²) within a region of the page 102. In this example, the print density threshold may also be expressed as a number of ink droplets within the region. If the predicted number of ink droplets to be deposited within a region of the page 102 exceeds the print density threshold, then this may be an indication that printing in the region of the page 102 is likely to produce curling on the page 102.

In some other examples, the print density may be measured as the predicted mass (e.g., nanograms) of deposited ink 106. In this case, the print density threshold may also be expressed as a mass of deposited ink 106. If the predicted mass of ink 106 to be deposited within a region of the page 102 exceeds the print density threshold, then this may be an indication that printing in the region of the page 102 is likely to produce curling on the page 102.

In yet another example, the print density may be measured as the predicted volume (e.g., nanoliters) of ink 106 to be deposited within a region of the page 102. In this case, the print density threshold may also be expressed as a volume of deposited ink 106. If the predicted volume of ink 106 to be deposited within a region of the page 102 exceeds the print density threshold, then this may be an indication that printing in the region of the page 102 is likely to produce curling on the page 102. Of course, the foregoing could apply similarly for other agents and colorants.

In some examples, determining that printing in the region of the page 102 is likely to produce curling on the page 102 may be based on a combination of the print density and the page location of the region. For example, the curl analyzer 112 may consider both the location on the page 102 of the region and the print density (e.g., the amount of the ink 106) in the region. The curl analyzer 112 may weight certain regions and print densities differently. For example, a region that is located at either the top or bottom edge of the page 102 may be weighted higher than a region located in the center of the page 102. In another example, a low print density may have a lower weight than a high print density. The curl analyzer 112 may determine a weighted score for various regions based on the page location of the region and the print density of the ink 106 in the region. If the weighted score of a region exceeds a certain threshold, then curling is likely to occur.

In some examples, the placement of the ink 106 on a duplex page 102 may be used to determine the likelihood of curling. The curl analyzer 112 may take into consideration the region(s) and print densities of the ink 106 on both sides of the page 102 when determining whether curling is likely to occur. For example, if the ink 106 is to be deposited in one region on one side of the page 102 and not in another region of the second side of the page 102, then curling may be likely to occur. In another example, certain print densities on both sides of the page 102 may be likely to produce curling.

The processor 110 may include an ink depletion modifier 114. The ink depletion modifier 114 may cause the printing device 100 to print the region of the page 102 with a depleted amount of ink 106 in response to determining that printing the region at the page location with the print density is likely to produce curling of the page 102. For example, for a region of the page 102 with a print density that exceeds the print density threshold for that page location, a depleted (e.g., reduced) amount of the ink 106 may be applied to the page during printing. This approach may be referred to as ink depletion or depleted ink printing. Ink depletion may be achieved by reducing the amount of ink 106 that is applied to the page 102 from an original (e.g., unmodified) amount of ink 106. It should be noted that in some examples, the ink depletion modifier 114 may be a representation of instructions executed by the processor 110.

In the case where the ink 106 is a black ink, an amount (e.g., a percentage) of the black ink 106 may be reduced from an original amount. The result is that the black areas curl less due to less black ink 106 being applied, which reduces the differential stress across the page. In an example, the black ink 106 may be reduced by 10%-25%. Therefore, the region may be printed by using 75% of the black ink 106 that was originally indicated by the ink signal. It should be noted that the values used in this example are provided for illustrative purposes.

The amount of ink depletion used to mitigate curl may vary based on various print properties. For example, ink formulation, media properties, mechanical page conditioning and/or print speed may impact the amount of ink depletion used.

In some examples, the amount of ink depletion may be configurable. For example, a high amount (e.g., 25%) of ink depletion may be performed for some pages 102 and/or regions of a page 102 while a low amount (e.g., 10%) of ink depletion may be performed for other pages 102 and/or regions of a page 102. In some examples, the amount of ink depletion may be user-selectable.

In some examples, the amount of ink depletion may be based on finishing operations that will be applied to a page 102. For example, the printing device 100 may print the region of the page 102 with a depleted amount of ink 106 based on a finishing operation for the page 102. When determining whether to perform the depleted ink printing, this determination may also be based on the destination of the page 102. For pages 102 that are going to be stapled in a finisher, pages 102 may have to be carefully lined up and collated before the staple is driven through. Therefore, the depleted ink printing described herein may be of particular interest for stapled jobs or print jobs that include other finishing processes (e.g., cutting, binding, output offset, etc.). However, if a page 102 is to be output to an output bin without additional finishing, then a low amount of ink depletion may be performed. In this case, a certain amount of curl may be acceptable.

In some examples, the depleted ink printing may also be a user-selectable feature. For example, a user may choose to enable the modified printing to provide extra-flat output. In this case, the depleted amount of ink 106 may be configurable based on a target amount of curl reduction. For example, a user may select the target amount of curl reduction. The depleted amount of ink 106 may then be applied to the page 102 to achieve the target amount of curl reduction.

In some examples, the ink depletion may be performed for all documents and/or images. For example, the ink depletion modifier 114 may cause the printing device 100 to print all regions of the page 102 with a depleted amount of an ink 106 whenever printing in one region of the page 102 is likely to produce curling of the page 102.

In some examples, the ink depletion may be performed in a subset of regions on a page 102 and not other regions. For example, the ink depletion modifier 114 may cause the printing device 100 to print regions of the page 102 with a depleted amount of an ink 106 when printing in those regions of the page 102 is likely to produce curling of the page 102. In this example, regions found to be unlikely to produce curling of the page 102 may be printed with an un-depleted amount of ink 106. As used herein, an un-depleted amount of ink 106 refers to an unmodified amount of ink 106 that is to be deposited on the page 102. In this case, the original ink signal may be used to print the regions found unlikely to produce curling of the page 102.

In some examples, the ink depletion may be performed by dynamically modifying the ink signal by a fixed or variable amount. The ink depletion may be accomplished through various techniques.

In some examples, ink depletion may be accomplished through input capture. With input capture, in image signal for the document to be printed may be represented in RGB triplets for each pixel. In the case of a black channel associated with the black ink 106, the unmodified image signal for the black regions may have an RGB value of (0,0,0). To produce ink depletion, the RGB value of the black regions may be changed to a dark grey value. For example, instead of an RGB value of (0,0,0), the RGB value may be changed to an RGB value of (25,25,25) to produce a dark gray. Therefore, when the ink signal is sent to the print zone 104, less ink will be applied to the page 102. In this approach, the black color is changed to a lighter black or gray color.

In other examples, depletion may be accomplished through color conversion. In this approach, a colormap may be used to perform color conversion of image pixels from RGB values to CMYK. To achieve ink depletion, an alternate colormap may be used for the black channel (K channel). For example, an image signal coming out of the black channel (K channel) may be multiplied by a certain value (e.g., 0.8) to reduce the amount of ink 106 used for that region.

In other examples, depletion may be accomplished through halftoning. In this approach, the ink values for a region are determined. Based on the ink values, the location of where ink droplets in the region are applied to the page 102 may be determined. A certain number of ink droplets may be removed from that region before printing. For example, if a region is determined to have 100,000 ink droplets for an unmodified ink signal, then a percentage (e.g., 20%) of the ink droplets can be removed for the ink depletion. In this example, instead of printing 100,000 ink droplets, 80,000 ink droplets may be applied to the page 102.

In yet other examples, depletion may be accomplished through shingle/expansion masking. In this approach, a certain number of nozzles used to eject the ink 106 may be masked off (e.g., turned off) to reduce the volume of ink 106 applied to the page 102. For example, upon determining where the ink droplets are going to be placed on the page 102, the individual nozzles on the printhead used to physically eject the ink 106 may be mapped to the ink droplets. With multipath printing, the path that the ink 106 will flow may also be determined. Upon mapping the nozzles and/or ink path, a certain number (e.g., 20%) of nozzles may be turned off. In other words, a signal may be sent to prevent a certain number of nozzles from ejecting ink 106. In some examples, this may be accomplished by overlaying a pattern on those nozzles that are to be turned off.

The described methods for curl compensation through selective ink depletion provide for reduced page curl, increased page flatness and reduced user intervention for regions of a document and/or documents with a predicted curl likelihood above a threshold. Additionally, cost and performance penalties may be avoided by not adding anti-curl additives to inks that are incompatible. Furthermore, cost and system complexity are also reduced because additional curl controlling mechanisms (e.g., extra rollers, surfaces, dryers, fusers and/or hold-downs) may be avoided.

As described above, in some examples the printing device 100 may be a page-wide inkjet printer. In other examples, the printing device 100 may be a scanning inkjet printer in which the printhead(s) of the printing device 100 move to different locations of the page 102. It should be noted that the described methods for modified printing may provide for enhanced curl compensation in page-wide inkjet printing and scanning inkjet printing. But with page-wide inkjet printing, the described methods for modified printing may provide for curl compensation without a scanning printhead.

The printing device 100 may include additional components (not shown). Further, some of the components described herein may be removed and/or modified without departing from the scope of this disclosure. The printing device 100 as depicted in FIG. 1 may not be drawn to scale and may have a different size and/or configuration than shown. In another example, the printing device 100 may use any of a number of printing techniques where moisture is added to the page. For example, the printing device 100 may be an inkjet printer.

In addition, the apparatuses disclosed herein for curl compensation through selective ink depletion may be external to the printing device 100. For instance, the apparatuses disclosed herein may be computing device(s) that are external to the printing device 100. The external computing device(s) may determine that curling is likely to occur on the printed page 102. The disclosed apparatuses may then cause the printing device 100 to print the region of the page 102 with a depleted amount of an ink in response to determining that printing the region at the page location with the print density is likely to produce curling of the page 102.

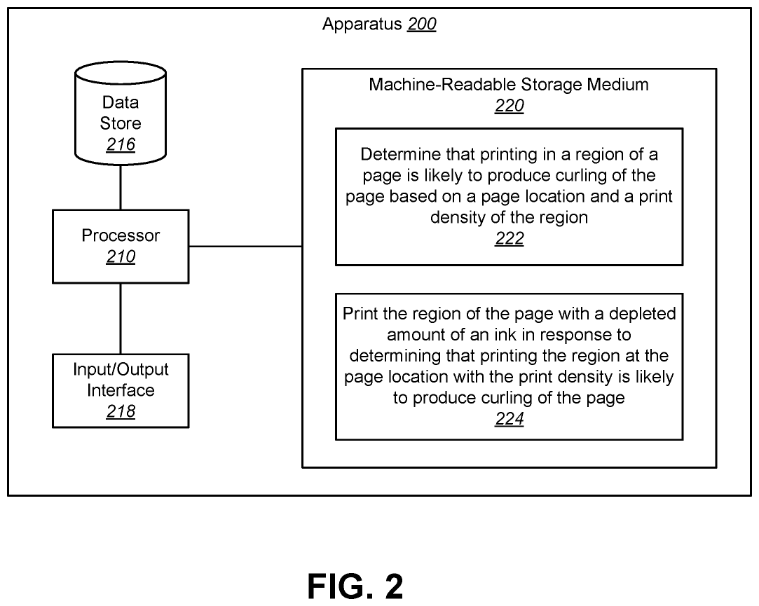

FIG. 2 is a block diagram of an example of an apparatus 200 that may be used in an example of a method for curl compensation through selective ink depletion. The apparatus 200 may be a computing device, such as a personal computer, a server computer, a printer, a smartphone, a tablet computer, etc. In an example, the apparatus 200 may be equivalent to the printing device 100 and/or the processor 110 depicted in FIG. 1. The apparatus 200 may include a processor 210, a data store 216, an input/output interface 218, and a machine-readable storage medium 220. The apparatus 200 may further include additional components (not shown) and some of the components described herein may be removed and/or modified without departing from the scope of this disclosure.

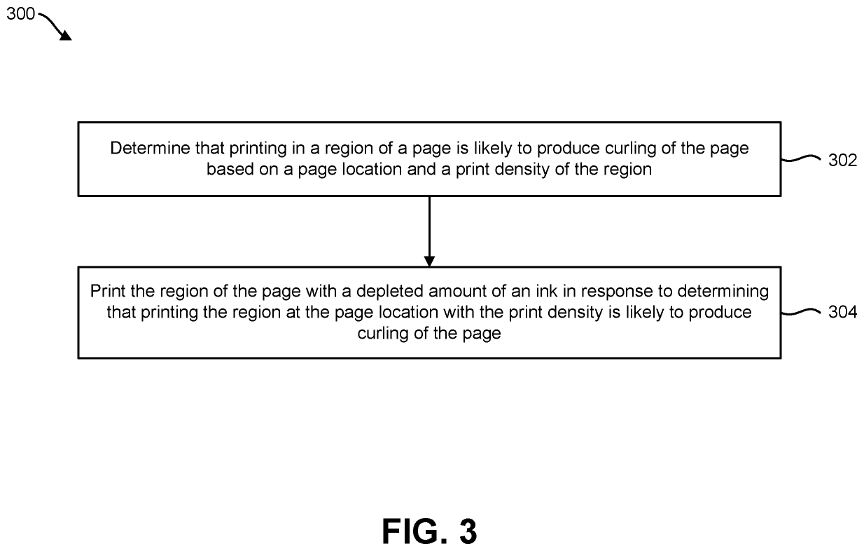

The processor 210 may be any of a central processing unit (CPU), a semiconductor-based microprocessor, GPU, FPGA, an application-specific integrated circuit (ASIC), and/or other hardware devices suitable for retrieval and execution of instructions stored in the machine-readable storage medium 220. The processor 210 may fetch, decode, and execute instructions, such as instructions 222-224 stored on the machine-readable storage medium 220, to control processes to determine 222 that printing in a region of a page is likely to produce curling of the page based on a page location and a print density of the region; and print 224 the region of the page with a depleted amount of an ink in response to determining that printing the region at the page location with the print density is likely to produce curling of the page. As an alternative or in addition to retrieving and executing instructions, the processor 210 may include an electronic circuit and/or electronic circuits that include electronic components for performing the functionalities of the instructions 222-224. These processes are described in detail below with respect to FIGS. 3-5.

The machine-readable storage medium 220 may be any electronic, magnetic, optical, or other physical storage device that contains or stores executable instructions. Thus, the machine-readable storage medium 220 may be, for example, RAM, EEPROM, a storage device, an optical disc, and the like. In some implementations, the machine-readable storage medium 220 may be a non-transitory machine-readable storage medium, where the term “non-transitory” does not encompass transitory propagating signals.

The apparatus 200 may also include a data store 216 on which the processor 210 may store information, such as information pertaining to the images to be printed. The data store 216 may be volatile and/or non-volatile memory, such as DRAM, EEPROM, MRAM, phase change RAM (PCRAM), memristor, flash memory, and the like.

The apparatus 200 may further include an input/output interface 218 through which the processor 210 may communicate with an external device(s) (not shown), for instance, to receive and store the information pertaining to the images to be printed. The input/output interface 218 may include hardware and/or machine-readable instructions to enable the processor 210 to communicate with the external device(s). The input/output interface 218 may enable a wired or wireless connection to the external device(s). The input/output interface 218 may further include a network interface card and/or may also include hardware and/or machine-readable instructions to enable the processor 210 to communicate with various input and/or output devices, such as a keyboard, a mouse, a display, another computing device, etc., through which a user may input instructions into the apparatus 200.

FIG. 3 is a flow diagram illustrating an example of a method 300 for curl compensation through selective ink depletion. The method 300 for curl compensation through selective ink depletion may be performed by, for example, the processor 110 and/or the apparatus 200.

The apparatus may determine 302 that printing in a region of a page 102 is likely to produce curling of the page 102 based on a page location and a print density of the region. For example, the apparatus may determine that the page location of the region is associated with page curl. A region and/or regions of the page 102 may be identified with a predicted curl likelihood above a threshold. The apparatus may determine if the ink 106 is to be applied in a certain region of the page 102 that is likely to curl as a result of the ink application. Curl on the bottom edge and/or top edge of the page 102 may produce curl of the page 102. Therefore, determining 302 that printing in the region of the page 102 is likely to produce curling of the page 102 may include determining that the region is located at a top or bottom of the page 102.

In another example, the apparatus may determine that the print density in the region exceeds a print density threshold for the page location of the region. A certain amount of the ink 106 deposited in a region of the page 102 may be likely to cause curling of the page 102. The apparatus may determine if the print density (e.g., the amount of deposited ink within a region of the page 102) of the ink 106 would exceed a print density threshold indicating that curling is likely. The print density threshold may be based on the page location of the region. For example, a region located at the top or bottom of the page 102 may have a lower print density threshold than other regions of the page 102.

In yet another example, the apparatus may determine that the region is located next to an unprinted region of the page 102. For example, the apparatus may determine that the ink 106 will be printed in a first region of the page 102 but not in a second region that is next to the first region.

The apparatus may print 304 the region of the page 102 with a depleted amount of an ink 106 in response to determining that printing the region at the page location with the print density is likely to produce curling of the page 102. In some examples, the ink 106 may be a black ink lacking an anti-curl agent.

In an example, the apparatus may apply a reduced amount of ink 106 to the page 102 in the region identified as likely to cause curling. In this approach, a certain percentage of the ink 106 may be reduced when printed. An ink signal may be modified to print with the depleted amount of the ink 106 in response to determining that printing the region at the page location and with the print density is likely to produce curling of the page 102.

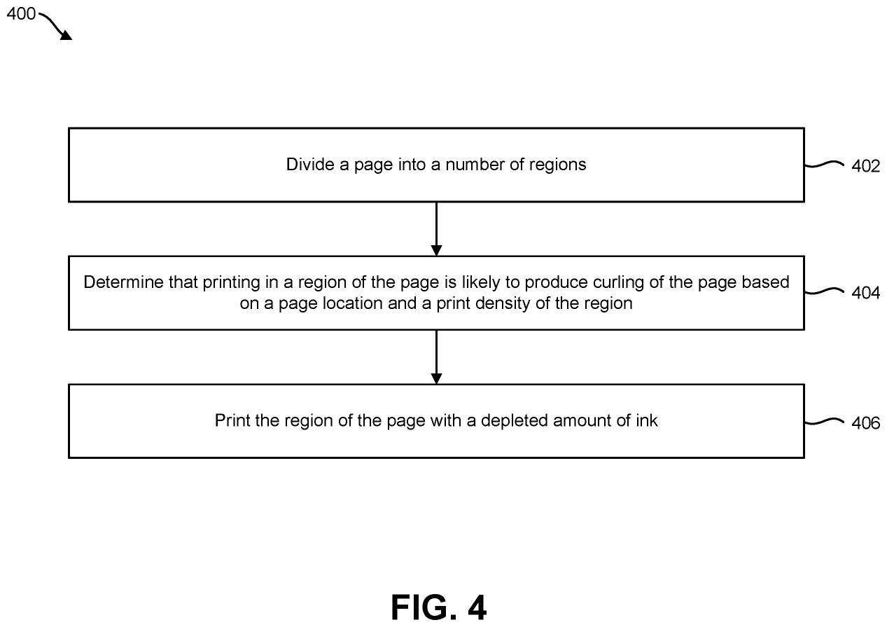

FIG. 4 is a flow diagram illustrating another example of a method 400 for curl compensation through selective ink depletion. The method 400 for curl compensation through selective ink depletion may be performed by, for example, the processor 110 and/or the apparatus 200.

The apparatus may divide 402 a page 102 into a number of regions. For example, before printing the page 102, the apparatus may divide 402 the page 102 into a number of regions (e.g., zones). The regions may be sized and located on the page based on the likelihood of curl due to printing in the region. In an example, the page 102 may be divided 402 into a top region a bottom region a left side region a right side region and a center region. It should be noted that the number and location of the regions may differ from this example.

The apparatus may determine 404 that printing in a region of the page 102 is likely to produce curling of the page 102 based on a page location and a print density of the region. This may be accomplished as described in connection with FIG. 3. For example, the apparatus may determine that the print density in a region exceeds a print density threshold for the page location of the region. The apparatus may analyze a given region to determine whether the print density of the given region exceeds the print density threshold for that region.

In another example, the apparatus may determine whether the difference between the print densities of neighboring regions exceeds a threshold. For example, the apparatus may determine whether a region with a high print density is located next to an unprinted region of the page 102. A high concentration of the ink 106 in a region next to an unprinted region may be likely to cause curling.

The apparatus may weight certain regions and print densities differently. For example, a region that is located on at the top or bottom edge of the page 102 may be weighted higher than a region located in the center of the page 102. In another example, a low print density may have a lower weight than a high print density. The apparatus may determine a weighted score for various regions based on the location of the region and the print density of the ink 106. If the weighted score of a region exceeds a certain threshold, then curling is likely to occur.

The apparatus may print 406 the region of the page 102 with a depleted amount of ink 106 in response to determining that printing the region at the page location with the print density is likely to produce curling of the page 102. For example, the apparatus may cause the printing device 100 to apply a reduced amount of ink 106 in the regions that are determined likely to produce curling of the page 102. This may be accomplished as described in connection with FIG. 1. In some examples, ink depletion may be accomplished through input capture, color conversion, halftoning and/or shingle/expansion masking.

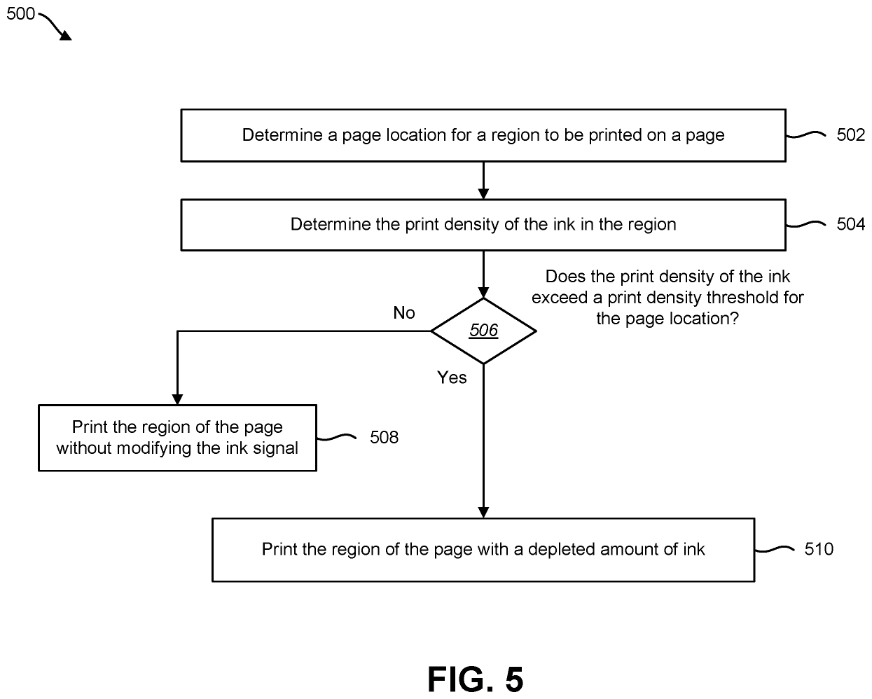

FIG. 5 is a flow diagram illustrating yet another example of a method 500 for curl compensation through selective ink depletion. The method 500 for curl compensation through selective ink depletion may be performed by, for example, the processor 110 and/or the apparatus 200.

The apparatus may determine 502 a page location for a region to be printed on the page 102. For example, the apparatus may divide the page 102 into a number of regions. Each region may be associated with a certain page location (e.g., top of page 102, bottom of page 102, etc.).

The apparatus may determine 504 the print density of the ink 106 in the region. For example, the print density may be measured as the predicted number of ink droplets to be deposited within a region of the page 102. In other examples, the print density may be measured as the predicted mass and/or volume of ink 106 to be deposited within a region of the page 102.

The apparatus may determine 506 whether the print density of the ink 106 exceeds a print density threshold for the page location. A certain amount of the ink 106 deposited in a region of the page 102 may be likely to cause curling of the page 102. The apparatus may determine if the print density (e.g., the amount of deposited ink within a region of the page 102) of the ink 106 would exceed a print density threshold indicating that curling is likely. The print density threshold may be based on the page location of the region. For example, a region located at the top or bottom of the page 102 may have a lower print density threshold than other regions of the page 102. If the print density of the ink 106 does not exceed the threshold, then the apparatus may print 508 the region of the page 102 without modifying the ink signal. In other words, the apparatus may print 508 the region of the page 102 without reducing (e.g., depleting) the ink 106 in the region.

If the apparatus determines 506 that the print density of the ink 106 exceeds the print density threshold for the page location, then the apparatus may print 510 the region of the page 102 with a depleted amount ink 106. In this case, the apparatus may reduce the amount of ink 106 that is applied to the page 102 in that region. This may be accomplished as described in connection with FIG. 1.

1. A method, comprising:
determining that printing in a region of a page is likely to produce curling of the page based on a page location and a print density of the region; and
printing the region of the page with a depleted amount of an ink in response to determining that printing the region at the page location with the print density is likely to produce curling of the page.

2. The method of claim 1, wherein determining that printing in the region of the page is likely to produce curling of the page comprises determining that the page location of the region is associated with page curl.

3. The method of claim 1, wherein determining that printing in the region of the page is likely to produce curling of the page comprises determining that the region is located at a top or bottom of the page.

4. The method of claim 1, wherein determining that printing in the region of the page is likely to produce curling of the page comprises determining that the print density in the region exceeds a print density threshold for the page location of the region.

5. The method of claim 1, wherein determining that printing in the region of the page is likely to produce curling of the page further comprises determining that the region is located next to an unprinted region of the page.

6. A computing device, comprising:
a memory;
a processor coupled to the memory, wherein the processor is to:
determine that printing in a region of a page is likely to produce curling of the page based on a page location and a print density of the region; and
cause a printing device to print the region of the page with a depleted amount of an ink in response to determining that printing the region at the page location with the print density is likely to produce curling of the page.

7. The computing device of claim 6, wherein the ink comprises a black ink lacking an anti-curl agent.

8. The computing device of claim 6, wherein the printing device is a page-wide inkjet printer.

9. The computing device of claim 6, wherein the depleted amount of the ink is based on a finishing operation for the page.

10. The computing device of claim 6, wherein an ink signal is modified to print with the depleted amount of the ink in response to determining that printing the region at the page location and with the print density is likely to produce curling of the page.

11. The computing device of claim 6, wherein the depleted amount of the ink is configurable based on a target amount of curl reduction.

12. A non-transitory machine-readable storage medium encoded with instructions executable by a processor, the machine-readable storage medium comprising:
instructions to divide a page into a number of regions;
instructions to determine that printing in a region of the page is likely to produce curling of the page based on a page location and a print density of the region; and
instructions to print the region of the page with a depleted amount of an ink in response to determining that printing the region at the page location with the print density is likely to produce curling of the page.

13. The machine-readable storage medium of claim 12, wherein the instructions to determine that printing in the region of the page is likely to produce curling of the page comprise:
instructions to determine the print density in the region; and
instructions to determine that the print density in the region exceeds a print density threshold.

14. The machine-readable storage medium of claim 12, wherein the print density threshold is based on the page location of the region.

15. The machine-readable storage medium of claim 12, further comprising:
instructions to print a second region of the page with an un-depleted amount of the ink in response to determining that printing the second region is unlikely to produce curling of the page.
